(19) United States
(12) Patent Application Publication
(10) Pub. No.: US 2009/0094189 A1
(43) Pub. Date: Apr. 9, 2009

(54) METHODS, SYSTEMS, AND COMPUTER PROGRAM PRODUCTS FOR MANAGING TAGS ADDED BY USERS ENGAGED IN SOCIAL TAGGING OF CONTENT

(75) Inventor: Robert Todd Stephens, Sharpsburg, GA (US)

Correspondence Address: AT&T Legal Department - MB;Attn: Patent Docketing, Room 2A-207, One AT&T Way, Bedminster, NJ, 07921, US

(73) Assignee: AT&T BLS Intellectual Property, Inc.

(21) Appl. No.: 11/868,674

(22) Filed: Oct. 8, 2007

(51) Int. Cl. G06F 17/30

(52) U.S. Cl. 707/2; 707/E17.123

(57) ABSTRACT

Methods, systems and computer program products for managing tags added by users engaged in social tagging of content accessible via a communications network include identifying critical words associated with content accessed by a user, and recommending one or more content-descriptive tags to the user based on critical words identified in the content. Identifying critical words in content includes assigning a weighted value to content words, for example, based on occurrence and location of content words within the content. Identifying critical words in content also includes assigning a weighted value to content words, for example, based on the position on a content word inventory curve, such as a “long tail” curve. The position on a long tail curve defines popularity of content words in other social tags currently in use.

### FIELD OF THE APPLICATION

The present application relates generally to communications networks, and, more particularly, to methods, systems, and computer program products for obtaining content via communications networks.

### BACKGROUND

Communications networks are widely used for nationwide and worldwide communication of voice, multimedia and/or data. As used herein, the term “communications networks” includes public communications networks, such as the Public Switched Telephone Network (PSTN), terrestrial and/or satellite cellular networks, private networks and/or the Internet.

The Internet is a decentralized network of computers that can communicate with one another via Internet Protocol (IP). The Internet includes the World Wide Web (web) service facility, which is a client/server-based facility that includes a large number of servers (computers connected to the Internet) on which web pages or files reside, as well as clients (web browsers), which interface users with the web pages. The topology of the web can be described as a network of networks, with providers of network services called Network Service Providers, or NSPs. Servers that provide application-layer services may be referred to as Application Service Providers (ASPs). Sometimes a single service provider provides both functions.

Vast amounts of information or “content” are available on the web including, but not limited to text, images, applications, video, and audio content. Web users are also increasingly making their own personal content (e.g., home movies, photograph albums, audio recordings, etc.) available via the web through web sites, web logs (blogs), and the like. In addition, television networks, including traditional broadcast networks as well as cable and satellite television networks, are making content available via the web. Unfortunately, the sheer amount of available content and the increasing numbers of content providers are posing increasingly more difficult challenges to users with respect to finding content of interest.

Recent studies have uncovered some alarming facts with regard to how much time and money are spent by enterprise employees engaged in finding information. For example, the average knowledge worker spends 50 percent of his/her time looking for information. The number of copies an organization makes of each document averages 19. In an IDC (www.idc.com) report, entitled “The High Cost of Not Finding Information,” it is demonstrated that an enterprise with 1,000 knowledge workers can lose anywhere from $2.5 million $3.5 million annually in intellectual rework, time spent searching for non-existent data, and failing to find existing information. The lost opportunity costs, however, are even greater—an additional $15 million in lost revenues. In another IDC report, entitled “Quantifying Enterprise Search”, it was found that only 21% of respondents said they found the information they needed 85% to 100% of the time. 40% of corporate users reported that they can not find the information they need to do their jobs on their enterprise intranets.

The concept of “social tagging” has emerged recently and describes the collaborative activity of marking shared online content with keywords or tags as a way to organize content for future navigation, filtering, or search. Traditional information architecture utilized a central taxonomy or classification scheme in order to place information into specific pre-defined buckets or categories. The assumption was that trained librarians understood more about information content and context than the average user. While this might have been true for the local library with the utilization of the Dewey Decimal system, the enormous amount of content on the Internet makes this type of system unmanageable.

Social tagging offers a number of benefits to the end user community. Perhaps the most important feature to the individual is the ability to bookmark information in a way that is easy to recall at a later date. In addition, by combining social tags, users can create an environment where the opinions of the majority define the appropriateness of the tags themselves. The act of creating a collection of popular tags is referred to as a folksonomy which is defined as a folk taxonomy of important and emerging content within a user community. Unfortunately, a vocabulary problem exists because different users may define content in different ways which may lead to missed information or inefficient user interactions.

An example of social tagging is the Web site “Flickr” (www.flickr.com), which allows users to upload images and “tag” them with appropriate metadata keywords. Other users, who view the images, can also tag them with their concept of appropriate keywords. After a critical mass has been reached, the resulting tag collection will identify images correctly and without bias. Another Web site dedicated to social bookmarking is del.icio.us, which provides users with a place to store, categorize, annotate and share favorite Web pages and files.

Social tagging can be a beneficial way to locate content if users understand the context and tagging of information. On the Internet, where social tagging emerged, there may be a pool of several thousand people engaged in the social tagging of content. Because of the large number of participants, the vocabulary and context of tags utilized will generally be understood by most users. However, in the corporate environment, there may be a much smaller number of users who engage in social tagging of internal content (i.e., content on the corporate intranet) and external content (i.e., content on the Internet). For example, in a large corporation of several thousand people, there may be fewer than one hundred users engaged in social tagging. The vocabulary and context of tags created by the few engaged in social tagging may not be understood by others in the corporation seeking content.

### SUMMARY

According to embodiments of the present invention, systems, methods, and computer program products are provided that facilitate the management of tags added by users engaged in social tagging of content (e.g., text content, audio content, video content, etc.) that is accessible via a communications network. Embodiments of the present invention enable enterprise users to locate more prevalent content than before, which may lower the cost of doing business and finding information.

According to some embodiments of the present invention, a method of managing tags added by users engaged in social tagging of content accessible via a communications network, includes identifying critical words associated with content accessed by a user, and recommending one or more content-descriptive tags to the user based on critical words identified in the content. Identifying critical words in content includes assigning a weighted value to content words, for example, based on occurrence and location of content words within the content. Identifying critical words in content also includes assigning a weighted value to content words, for example, based on the position on a content word inventory curve, such as a “long tail” curve. The position on a long tail curve defines the popularity of content words in other social tags currently in use.

In some embodiments, assigning a weighted value to content words includes assigning a first weighted value based on occurrence and location of content words within the content, assigning a second weighted value based on position on a content word inventory curve, wherein the content word inventory curve defines popularity of content words in other social tags, and adding the first and second weighted values for each respective content word. A content word inventory curve, according to some embodiments of the present invention, defines a head portion, a body portion, and a long tail portion. The head portion represents an upper percentile of tag popularity, the body portion represents an intermediate percentile of tag popularity, and the long tail portion represents a lower percentile of tag popularity.

In some embodiments of the present invention, altering a content-descriptive tag entered by a user to a standardized format includes removing stop words from a tag, correcting tense of a tag, changing case of a tag, and/or replacing a tag with a synonymous tag.

According to some embodiments of the present invention, a system for managing tags added by users engaged in social tagging of content accessible via a communications network, includes a tag recommender that identifies critical words associated with content accessed by a user, and that recommends one or more content-descriptive tags to the user based on critical words identified in the content. The tag recommender assigns a weighted value to content words based on occurrence and location of content words within the content. The tag recommender also assigns a weighted value to content words based on position on a content word inventory curve, wherein the content word inventory curve defines popularity of content words in other social tags.

In some embodiments, the tag recommender assigns a first weighted value to content words based on occurrence and location of content words within the content, and assigns a second weighted value to the content words based on position on a content word inventory curve. As described above, the content word inventory curve defines popularity of content words in other social tags. The tag recommender then adds the first and second weighted values for each respective content word and presents the words having the highest weight to a user as suggested tag words.

According to some embodiments of the present invention, a system for managing tags added by users engaged in social tagging of content accessible via a communications network, includes a tag correction component that alters a content-descriptive tag entered by a user to a standardized format. The tag correction component may remove stop words from a tag, correct the tense of tag words, change the case of tag words, and/or replace tag words with synonymous tag words. In some embodiments, the system includes a tag selection component that allows users to select tags from a tag cloud.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIG. 1 is a block diagram that illustrates a software/hardware architecture for a social tag management system, according to some embodiments of the present invention.

FIG. 2 illustrates a tag cloud that may be utilized in conjunction with embodiments of the present invention.

FIGS. 3A-3C illustrate a user interface for entering tag words, for accessing the tag correction module and tag recommender module of the social tag management system of FIG. 1, according to some embodiments of the present invention.

FIGS. 4-5 illustrate respective tables of a database for use in assigning weights to tag words and for assigning synonyms to tag words, according to some embodiments of the present invention.

FIG. 6 illustrates a content word inventory curve, referred to as a “long tail” curve, according to some embodiments of the present invention.

FIG. 7 illustrates the user interface of FIGS. 3A-3C displaying tag words recommended by the social tag management system of FIG. 1.

FIGS. 8-10 are flow charts that illustrate exemplary operations for managing tags added by users engaged in social tagging of content accessible via a communication network, according to some embodiments of the present invention.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, steps, operations, elements, and/or components, but does not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software, including firmware, resident software, micro-code, etc. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM).

As used herein, the term “content” means any type of audio content, video content, audio/video content, text, gaming content, interactive content, application content, etc., that can be delivered and/or performed/displayed via a communications network. For example, content may include television programs, movies, voice messages, music and other audio files, electronic mail/messages, web pages, interactive games, educational materials, software applications, etc.

Content tag “terms” and content tag “words” have the same meaning and are interchangeable.

Computer program code for carrying out operations of data processing systems discussed herein may be written in a high-level programming language, such as Java, AJAX (Asynchronous JavaScript), C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. Embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for managing tags added by users engaged in social tagging of content via a communications network, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

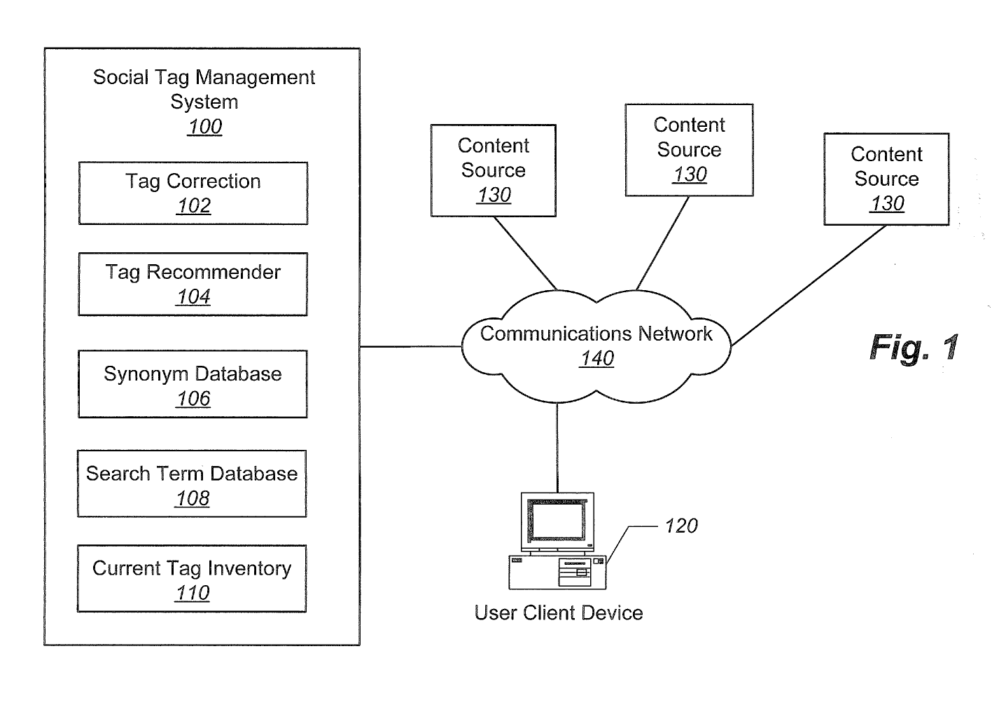

Referring to FIG. 1, a social tag management system 100 for managing tags added by users engaged in social tagging of content, according to some embodiments of the present invention, is illustrated. The illustrated social tag management system 100 is in communication with a communications network 140. The communications network 140 may represent a global network, such as the Internet, or other publicly accessible network. The communications network 140 may also, however, represent a wide area network, a local area network, an Intranet, or other private network, which may not accessible by the general public. Furthermore, the communications network 140 may represent a combination of public and private networks or a virtual private network (VPN). The communications network 140 may also contain transmissions over-the-air or through a dedicated distribution network. The communications network 140 may also be wireless or wireline, or may include wireless and wireline portions.

Via user client devices 120 (e.g. user devices executing a browser application) such as a personal computer, wireless communications device, packet-based network video device, etc., a user searches for and accesses content, and engages in social tagging of content available through the communications network 140, for example via various content sources 130. A content source 130 may be any source of content that can be accessed by a user e.g., web pages, databases, archives, etc. Content at a content source 130 may include any type of content e.g., text, images, applications, video, and audio content, etc. The social tag management system 100 facilitates each of these user activities. Specifically, the social tag management system 100, according to some embodiments of the present invention, includes the following: a tag correction module 102, a tag recommender module 104, a synonym database 106, a search term database 108, and a current tag inventory (i.e., tag cloud) 110. Each of these modules and their respective functions are described below.

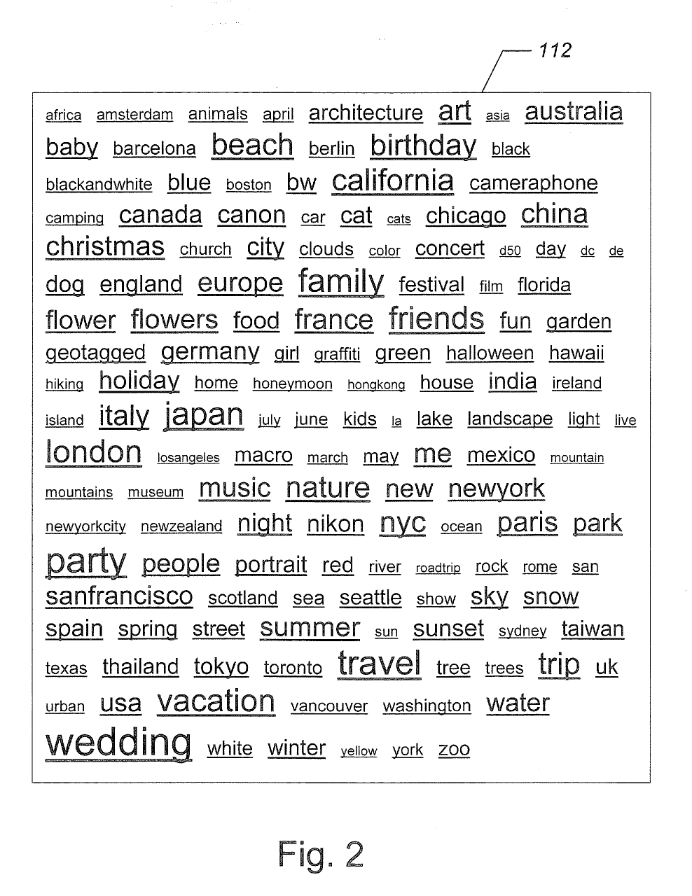

The current tag inventory 110 tracks current tags in use (i.e., content tags assigned by users to describe content), including the frequency of those terms in use. A visual representation of a current tag inventory 110 is commonly referred to as a “tag cloud.” An exemplary tag cloud 112 is illustrated in FIG. 2. A tag cloud (or weighted list in visual design) can be used as a visual depiction of content tags associated with content accessible by users. In some embodiments, more frequently used tags are depicted in a larger font or are otherwise emphasized, while the displayed order is generally alphabetical. Thus both finding a tag alphabetically and by popularity is possible, according to embodiments of the present invention. Selecting a single tag within a tag cloud will generally lead to a collection of items that are associated with that tag.

The tag correction module 102 is configured to receive content tags entered by a user (i.e., the terms/words used in the content tags) engaged in social tagging and perform various functions, including altering a content-descriptive tag entered by a user to a standardized format, and recommending alternative tags and/or additional tags. Altering a content-descriptive tag entered by a user to a standardized format may include removing stop words from a tag, correcting tense of a tag, changing case of a tag, and/or replacing a tag with a synonymous tag. Altering tags to a standardized format includes removing selected “stop words”, such as a, an, the, what, this, that, then, these, etc. The tense of words in a tag are changed, for example to the present tense. As an example, the words “helped”, “helping”, “helps” are all converted to the present tense “help.” Words may also be changed to have the same case. For example, all upper case letters are converted to lower case (e.g. John Smith becomes John smith). Words may be changed to standardized terms (e.g., the terms “bls” and “bell south” are changed to “bellsouth”).

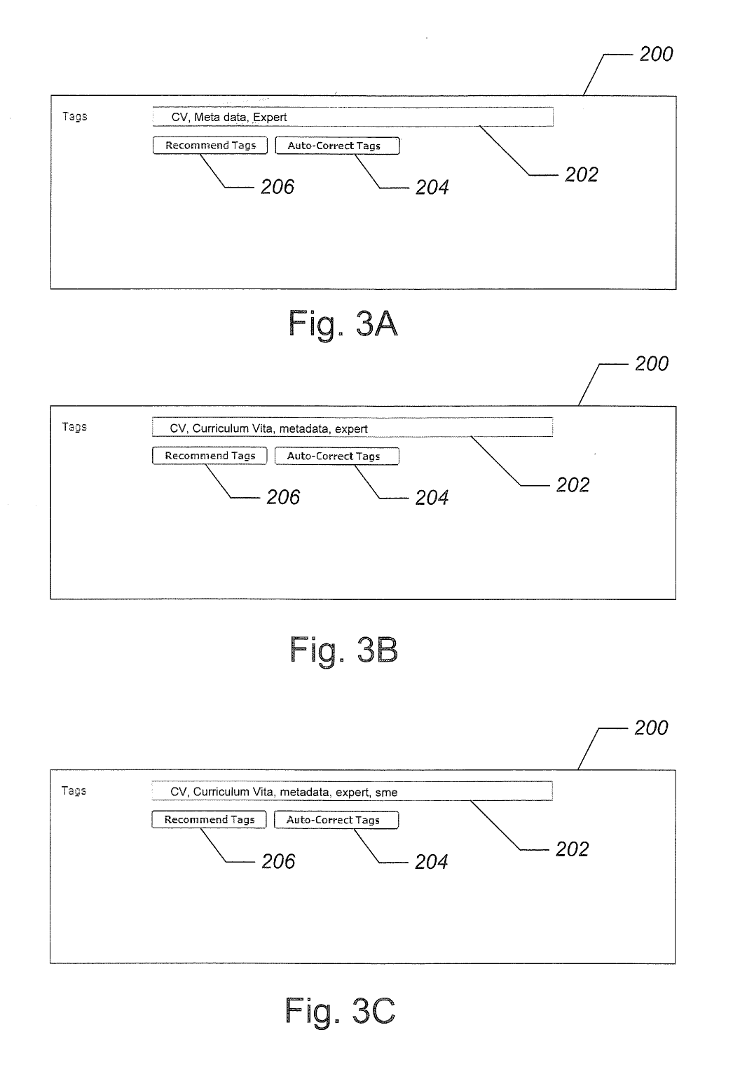

An example of operations of the tag correction module 102 is illustrated in FIGS. 3A-3C. In FIG. 3A, a user has accessed particular content through the user client device 120 and now would like to add a tag to the content containing the words: “CV”, “Meta data”, and “Expert” via the user interface 200 provided by the social tag management system 100 (FIG. 3A). Upon user activation of GUT control 204, labeled “Auto-Correct Tags”, the tag correction module 102 corrects the tag words “Meta data” to the correct spelling “metadata” and adds the unabbreviated spelling of Curriculum Vita, as illustrated in FIG. 3B. In addition, the tag correction module 102 may be configured to add popular synonyms for the user's tag words. For example, the resulting tag includes the words “CV, Curriculum Vita, metadata, expert, sme”, as illustrated in FIG. 3C. (The term “sme” is an abbreviation for “subject matter expert”).

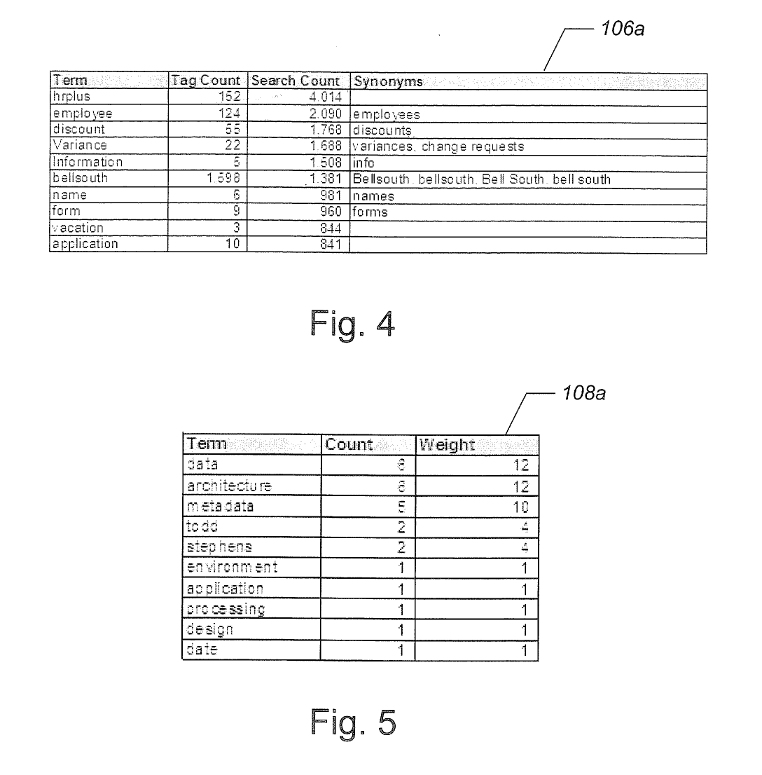

The tag recommender module 104 is configured to recommend tags to users engaged in social tagging of content. Upon user activation of GUI control 206, labeled “Recommend Tags”, the tag recommender module 104 makes recommendations for changes to terms/words used in content tags. The tag recommender module 104 utilizes one or more databases, including a synonym database 106 that stores synonyms for various tag words and a search term database 108 that stores search words and phrases collected by search engines. The synonym database 106 may include the structure illustrated in table 106a (FIG. 4). However, embodiments of the present invention are not limited to the illustrated table of FIG. 4. Synonym databases, according to embodiments of the present invention can have various tables and structures, without limitation. The synonym database 106 can be updated (i.e., tag word synonyms can be added, edited and deleted to/from table 106a) in real time or at scheduled times (e.g., daily, weekly, etc.) by administrators, authorized users, etc. Moreover, the synonym database 106 can be updated automatically via search engine analytic programs, etc.

The illustrated structure of the table 106a illustrated in FIG. 4 includes “terms”, “tag count”, “search count”, and “synonyms.” “Terms” are the individual words that are used in content tags. As such, any reference to “terms” is intended to mean “words” used in a content tag. Moreover, any reference to “tag” also includes the words within a content tag. “Tag count” is the number of times a particular word is used in a tag cloud (i.e., all of the tags associated with content that users have access to via a particular communications system). “Search count” is the number of times a particular word has been used in a search for content. “Synonyms” are other words that are synonymous with a particular word.

The search term database 108 may include the structure illustrated in table 108a (FIG. 5). However, embodiments of the present invention are not limited to the illustrated table of FIG. 5. Search term databases, according to embodiments of the present invention can have various tables and structures, without limitation. The search term database 108 can be updated (i.e., search terms/words can be added, edited and deleted to/from table 108a) in real time or at scheduled times (e.g., daily, weekly, etc.) by administrators, authorized users, etc. Moreover, the search term database 108 can be updated automatically via search engine analytic programs, etc.

The structure of the table 108a illustrated in FIG. 5 includes “terms”, “count”, and “weight”. “Terms” are the most popular words in content tags that people are using to locate information when performing content searches via search engines. Similar tags, search terms/phrases may be collected for analytics and mapping. The illustrated table 108a lists the top ten search words for a particular enterprise: hrplus, employee, discounts, Variance, Info, bellsouth, name, forms, vacation, and application.

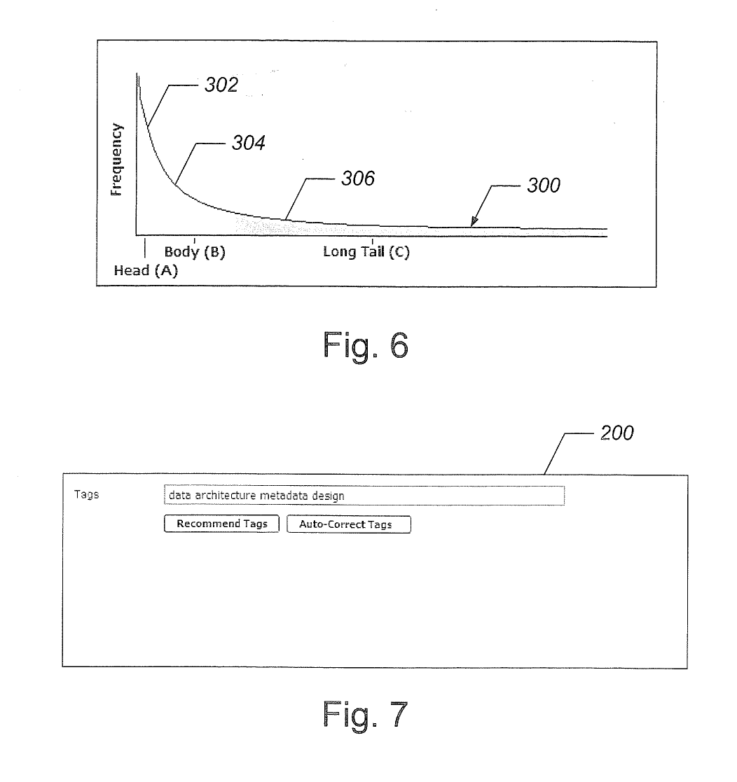

A weighting system is used by the term recommender module 104 to determine the most important or critical words used in a tag. For example, table 108a illustrates the assignment of weight values to search words in accordance with embodiments of the present invention. Content tag words are typically part of the title, headers or text of content and weights can be assigned to the words accordingly. For example, the following weights can be assigned to each class (location of words): Titles=3.0, Headers=2.0, and Text=1.0. The term recommender module 104 parses the text of content for which a user wishes to apply a tag thereto, counts the number of occurrences of a word, and applies a weight to each word based on the location of the word in the content. For example, the first time the word “collaboration” is encountered in the title of content, a count of 1 and a weight of 3 will be associated with the word “collaboration”, which provides a weight of 3 (1×3=3). The second occurrence of the word “collaboration” in a header provides a count of 2 and a weight of 5 ((1×3)+(1×2)=5). Table 108a in FIG. 5 illustrates the count and weight for various content words. The weights for the various terms are then adjusted based on the position of the words on a curve described below and referred to as the “long tail” of content tag inventory, illustrated in FIG. 6.

Referring to FIG. 6, the long tail curve 300 illustrates that a few key words used in content tags are popular, but the majority of content tag words are spread out and utilization of these words drops. The illustrated long tail curve 300 has three delineated areas: the head 302, the body 304, and the long tail 304. The head 302 represents about the top 2-5% of words in content tags and in keyword searches by users looking for content. The body 304 represents about the top 10-20% of words used in content tags and in keyword searches by users looking for content. The long tail 306 contains the remaining 80-85% of the words used in content tags and in keyword searches by users looking for content.

Weights are associated with words in each of the three areas of the long tail curve 300. For example, words in the head 302 may be assigned a weight of 3, words in the body 304 may be assigned a weight of 2, and words in the long tail 306 may be assigned a weight of 1. Various other weights may be assigned to words located within the head, body, and long tail portions of the long tail curve 300, these weights are provided for illustrative purposes.

Referring back to table 108a of FIG. 5, the weights of each of the words are adjusted based on their location on the long tail curve 300 of FIG. 6. For example, the word “design”, found in table 108a, has a weight of 1. Now, assuming that the word “design” is located in the head 302 of the long tail curve 300, the weight is adjusted upwardly to 9.

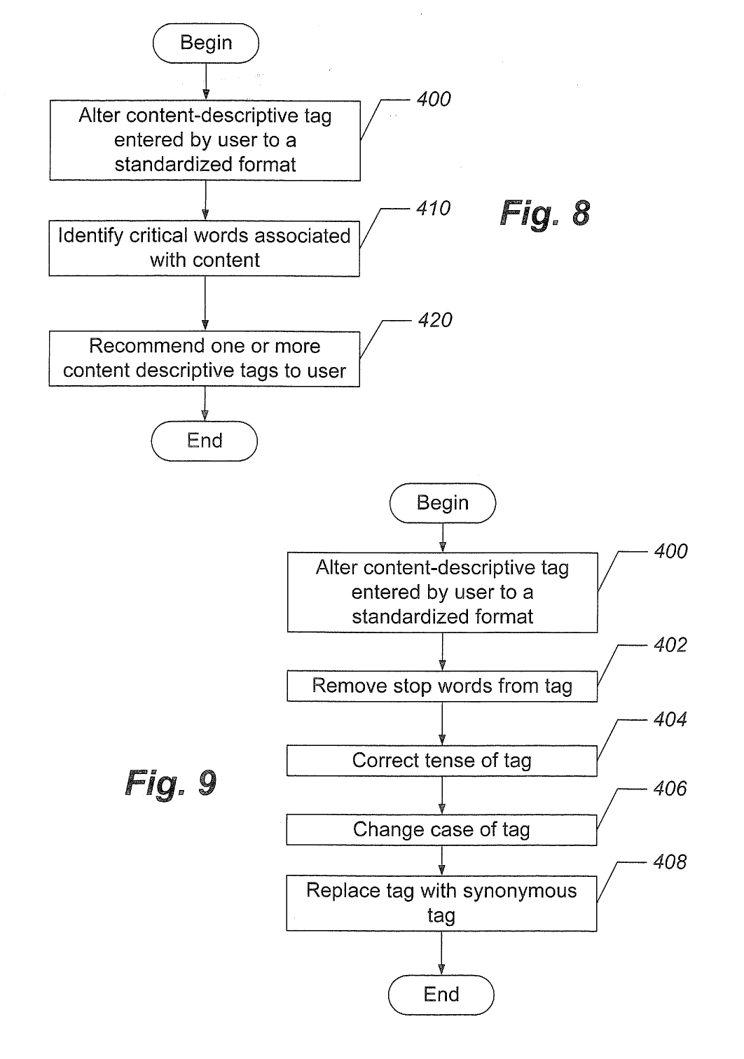

Accordingly, the order of the words in table 108a is changed such that the word “design” has the fourth highest weight. The tag recommender module 104 then recommends to a user the tag words “data”, “architecture”, “metadata”, “design” as content tags for particular content, because of their respective weights in modified table 108a, as illustrated in FIG. 7. As such, embodiments of the present invention provide a better control of content tags which would provide greater value to a business, because information would be easier to locate and the amount of time people spend searching for information can be reduced.

In some embodiments of the present invention, the tag recommender module 104 may include a tag selection component that allows a user to select tags (i.e., words/terms for use within content tags) for use with content from a tag cloud (i.e., from an inventory of tags).

Software code for performing the various functions of the social tag management system 100 may reside and/or execute entirely on a server device connected to the communications network 140 (or as part of a network service available via the communications network), entirely on the user client device 120 (e.g., within a browser application, etc.), or partially on a network service (or partially as part of a network service) and the user client device 120. Although FIG. 1 illustrates an exemplary social tag management system 100, it will be understood that the present invention is not limited to the illustrated modules and configuration, but is intended to encompass any configuration and any modules capable of carrying out the operations described herein.

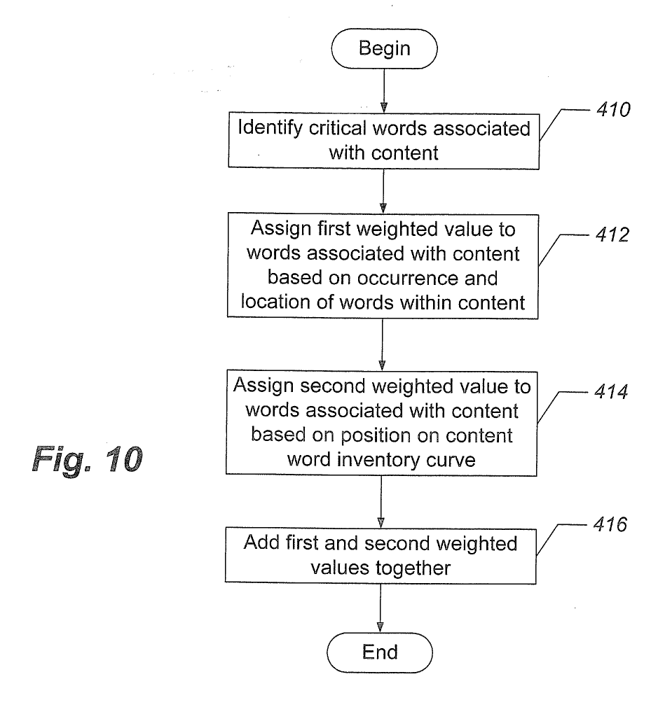

Exemplary operations for managing tags added by users engaged in social tagging of content accessible via the communication network 140, according to some embodiments of the present invention, will now be described with reference to FIGS. 8-10. Referring initially to FIG. 8, the following functions are performed on a content-descriptive tag entered by a user (e.g., a user that is adding a tag to describe content). Via the tag correction module 102, the contents of a tag (i.e., the individual words or terms in the content tag) are altered to a standardized format (Block 400). Via the tag recommender module 104, critical words associated with the content are identified (Block 410), and one or more content-descriptive tags are recommended to the user (Block 420).

Operations associated with altering content-descriptive tags entered by users performed by the tag correction module 102 (Block 400) include removing stop words from a tag (Block 402), correcting the tense of words within a tag (Block 404), changing the case of words in a tag (Block 406), and replacing words within a tag with synonymous words (Block 408). As described above, removing stop words from a tag (Block 402), involves identifying commonly used words that are irrelevant to the content (e.g., a, an, the, what, this, that, then, these, etc.) and removing these from a tag entered by a user. Correcting the tense of words within a tag (Block 404) involves changing the tense of words entered by a user to the same tense, for example, the present tense. Changing the case of words in a tag (Block 406) involves changing letters in a word to the same case. For example, all words in a tag are changed to lower case. Replacing words within a tag with synonymous words (Block 408) involves recommending words that are most commonly used in other tags by users associated with the particular content and/or words that are most commonly used by others in search requests for content.

Operations associated with identifying critical words associated with content performed by the tag recommender module 104 (Block 410) include assigning a first weighted value to words associated with content based on occurrence and location of the words within the content (Block 412), assigning a second weighted value to words associated with content based on a position of the words on a content word inventory curve (Block 414), and adding the first and second weighted values together (Block 416). Assigning a first weighted value to words associated with content based on occurrence and location of the words within the content (Block 412) involves assigning a weight as described above with respect to table 108a of FIG. 5. For example, a first weighted value is based upon whether a word is located in the title of content, the header of content, or the text of the content. Assigning a second weighted value to words associated with content based on a position of the words on a content word inventory curve (Block 414) involves assigning a weighted value based upon location of words on a long tail curve, such as long tail curve 300 of FIG. 7, as described above.

FIGS. 8-10 illustrate the architecture, functionality, and operations of some embodiments of methods, systems, and computer program products for managing tags added by users engaged in social tagging of content accessible via a communications network. In this regard, each block represents a module, segment, or portion of code, which comprises one or more executable instructions for implementing the specified logical function(s). It should also be noted that in other implementations, the function(s) noted in the blocks may occur out of the order noted in FIGS. 8-10. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of managing tags added by a user engaged in social tagging of content accessible via a communications network, the method comprising:
identifying critical words associated with content accessed by the user; and
recommending a content-descriptive tag to the user based on the critical words identified in the content.

2. The method of claim 1, wherein identifying critical words in content comprises assigning a weighted value to content words.

3. The method of claim 2, wherein assigning a weighted value to content words comprises assigning a weighted value to content words based on occurrence and location of content words within the content.

4. The method of claim 2, wherein assigning a weighted value to content words comprises assigning a weighted value to content words based on position on a content word inventory curve, wherein the content word inventory curve defines popularity of content words in other social tags.

5. The method of claim 2, wherein assigning a weighted value to content words comprises:
assigning a first weighted value based on occurrence and location of content words within the content;
assigning a second weighted value based on position on a content word inventory curve, wherein the content word inventory curve defines popularity of content words in other social tags; and
adding the first and second weighted values for each respective content word.

6. The method of claim 4, wherein the content word inventory curve defines a head portion, a body portion, and a long tail portion.

7. The method of claim 6, wherein the head portion represents an upper percentile of tag popularity, the body portion represents an intermediate percentile of tag popularity, and the long tail portion represents a lower percentile of tag popularity.

8. The method of claim 1, wherein content comprises audio content, video content, and text content.

9. The method of claim 1, further comprising altering a content-descriptive tag entered by the user to a standardized format.

10. The method of claim 9, wherein altering a content-descriptive tag entered by the user to a standardized format comprises one or more of the following: removing stop words from a tag, correcting tense of words in a tag, changing case of words in a tag, and replacing words in a tag with synonymous words.

11. A computer program product for managing tags added by a user engaged in social tagging of content accessible via a communications network, comprising:
a computer readable storage medium having computer readable program code embodied therein, the computer readable program code being configured to carry out the method of claim 1.

12. A system for managing tags added by a user engaged in social tagging of content accessible via a communications network, comprising a tag recommender that is configured to identify critical words associated with content accessed by the user, and to recommend a content-descriptive tag to the user based on the critical words identified in the content.

13. The system of claim 12, wherein the tag recommender is configured to assign a weighted value to content words based on occurrence and location of content words within the content.

14. The system of claim 12, wherein the tag recommender is configured to assign a weighted value to content words based on position on a content word inventory curve, wherein the content word inventory curve defines popularity of content words in other social tags.

15. The system of claim 12, wherein the tag recommender is configured to assign a first weighted value to content words based on occurrence and location of content words within the content, to assign a second weighted value to the content words based on position on a content word inventory curve, wherein the content word inventory curve defines popularity of content words in other social tags, and to add the first and second weighted values for each respective content word.

16. The system of claim 14, wherein the content word inventory curve defines a head portion, a body portion, and a long tail portion.

17. The system of claim 16, wherein the head portion represents an upper percentile of tag popularity, the body portion represents an intermediate percentile of tag popularity, and the long tail portion represents a lower percentile of tag popularity.

18. The system of claim 12, further comprising a tag correction component that is configured to alter a content-descriptive tag entered by the user to a standardized format.

19. The system of claim 18, wherein the tag correction component is configured to perform one or more of the following: remove stop words from a tag, correct tense of words in a tag, change case of words in a tag, and replace words in a tag with synonymous words.

20. The system of claim 12, further comprising a tag selection component that allows the user to select tags from a tag cloud.
